(19) United States
(12) Patent Application Publication
(10) Pub. No.: US 2025/0329789 A1
(43) Pub. Date: Oct. 23, 2025

(54) All-SOLID-STATE BATTERY AND MANUFACTURING METHOD THEREOF

(71) Applicant: TOYOTA JIDOSHA KABUSHIKI KAISHA, Toyota-shi (JP)

(72) Inventor: Toshihiro SHIMONAKA, Toyota-shi (JP)

(73) Assignee: TOYOTA JIDOSHA KABUSHIKI KAISHA, Toyota-shi (JP)

(21) Appl. No.: 19/077,222

(22) Filed: Mar. 12, 2025

(30) Foreign Application Priority Data
Apr. 22, 2024 (JP) 2024-069258

(51) Int. Cl. H01M 10/0585

(52) U.S. Cl. CPC H01M 10/0585; H01M 2300/0068; H01M 2300/0082

(57) ABSTRACT

The present disclosure provides an all-solid-state battery and a manufacturing method thereof capable of suppressing a decrease in the battery capacity while reducing the possibility of short circuit, even when plurality of unit cells are comprised. All-solid-state battery comprising a laminate 20 of a plurality of laminated units 22, wherein each of the plurality of laminated units 22 are laminated with each other at least either contact between the first electrode current collectors or contact between the second electrode current collectors, thereby forming the laminate 20, wherein each end 28 of the plurality of laminated units 22 has an inclined surface 24 towards the lamination plane 26 of each of the plurality of laminated units 22, and, wherein the laminate 20 has the minimum area projecting in the lamination direction of each of the plurality of laminated units 22.

### FIELD

The present disclosure relates to an all-solid-state battery and a method of manufacturing thereof.

### BACKGROUND

Among lithium ion batteries, all-solid-state batteries, in which the electrolyte solution is replaced with a solid electrolyte, have attracted attention. This is because all-solid batteries can be expected to further increase energy density by using a solid electrolyte instead of a conventional electrolyte solution.

The all-solid-state battery consists of a positive electrode current collector, a positive electrode active material layer, a solid electrolyte layer, a negative electrode active material layer, and a negative electrode current collector in this order. Therefore, if each of these layers become deformed and/or partially missing, a short circuit may occur between the positive and negative electrodes. Various attempts have been made to prevent this.

For example, PTL 1 discloses a laminate in which a positive electrode active material layer, a solid electrolyte layer, and a negative electrode active material layer are laminated in this order. PTL 1 also discloses that at least a part of the end of the laminate has a chamfered shape.

PTL 2 discloses cutting out a laminate from a sheet in which a positive electrode current collector, a positive electrode active material layer, a solid electrolyte layer, a negative electrode active material layer, and a negative electrode current collector are laminated in this order, and using it as an all-solid battery. PTL 2 also discloses that when cutting out the laminate, the cut surface has an inclined surface towards the lamination plane.

### CITATION LIST

### Patent Literature

[PTL 1] Japanese Unexamined Patent Publication No. 2015-50153

[PTL 2] International Publication No. WO 2019/221010

### SUMMARY

### Technical Problem

In the laminate disclosed in PTL1, chamfering the end thereof helps prevent the positive electrode active material layer, the solid electrolyte layer, and the negative electrode active material layer deforming and/or detaching, thereby reducing the possibility of a short circuit. However, sufficient consideration has not been given to short circuits in cases where the all-solid-state battery contains plurality of unit single cells. Also, while the all-solid-state battery disclosed in PTL 2 reduced the possibility of a short circuit even when the laminate contains plurality of unit cells, there has been a problem with the battery capacity decreasing.

The present disclosure aims to solve the above problem and provide an all-solid-state battery and a manufacturing method thereof capable of suppressing a decrease in the battery capacity while reducing the possibility of a short circuit, even when plurality of unit cells are included. It should be noted herein that, unless otherwise specified, the term “unit cell” means a battery in which a positive electrode current collector, a positive electrode active material layer, a solid electrolyte layer, a negative electrode active material layer, and a negative electrode current collector are arranged (laminated) in this order.

### Solution to Problem

The inventors have conducted extensive studies to achieve the above objective and have completed the all-solid-state battery and manufacturing method thereof disclosed herein. The embodiments are as follows.

### Aspect 1

All-solid-state battery comprising a laminate of a plurality of laminated units,

wherein, in each of the plurality of laminated units, at least one set of a first electrode current collector, a first electrode active material layer, a solid electrolyte layer, a second electrode active material layer, and a second electrode current collector are laminated in this order,

wherein each of the plurality of laminated units are laminated with each other at least either contact between the first electrode current collectors or contact between the second electrode current collectors, thereby forming the laminate,

wherein each end of the plurality of laminated units has an inclined surface towards the lamination plane of each of the plurality of laminated units, and,

wherein the laminate has the minimum area projecting in the lamination direction of each of the plurality of laminated units.

### Aspect 2

The all-solid-state battery according to Aspect 1, wherein in each of the plurality of laminated units, a first electrode current collector, a first electrode active material layer, a solid electrolyte layer, a second electrode active material layer, a second electrode current collector, a second electrode active material layer, a solid electrolyte layer, a first electrode active material layer, and a first electrode current collector are laminated in this order.

### Aspect 3

A method for manufacturing an all-solid-state battery, comprising:

laminating at least one set of a first electrode current collector, a first electrode active material layer, a solid electrolyte layer, a second electrode active material layer, and a second electrode current collector are laminated in this order to obtain a laminated unit,

preparing a plurality of the laminated units and laminating each of the laminated units together by at least either contact between the first electrode current collectors or contact between the second electrode current collectors to form a laminate,

forming an inclined surface at the end of the laminate towards the lamination plane, and

adjusting the position of each of the plurality of laminated units at the contact surfaces of the plurality of the laminated units so that the area projecting in the lamination direction of the laminate is minimized.

### Aspect 4

The method for manufacturing the all-solid-state battery according to Aspect 3, providing the laminated unit in which the first electrode current collector, the first electrode active material layer, the solid electrolyte layer, the second electrode active material layer, the second electrode current collector, the second electrode active material layer, the solid electrolyte layer, the first electrode active material layer, and the first electrode current collector are laminated in this order.

### ADVANTAGEOUS EFFECTS OF INVENTION

According to the present disclosure, since each end of the plurality of laminated units has an inclined surface towards laminated plane, it is possible to reduce the possibility of a short circuit, and by ensuring that the laminate has the minimum area projecting in the lamination direction, it is possible to provide an all-solid-state battery capable of suppressing a decrease in battery capacity.

Further, according to the present disclosure, by providing an inclined surface at the end of the laminate towards laminated plane and adjusting the positions of each of the plurality of laminated units at their contact surfaces of each of the plurality of laminated units so that the area projecting in the lamination direction of the laminate is minimized, it is possible to provide a manufacturing method capable of obtaining a desired all-solid-state battery.

### BRIEF DESCRIPTION OF DRAWINGS

FIG. 1 is a cross-sectional schematic view showing an example of a manufacturing method for an all-solid-state battery.

FIG. 2 is a cross-sectional schematic view showing the structure of the laminate with an inclined surface.

FIG. 3 is a cross-sectional schematic view showing an example of a part of the laminate. FIG. 4 is an enlarged cross-sectional schematic view of a region P shown by a dotted line in FIG. 3.

FIG. 5 is an enlarged cross-sectional schematic view of a region Q shown by a dotted line in FIG. 1.

FIG. 6 is a cross-sectional schematic view showing another aspect of forming the laminate.

### DESCRIPTION OF EMBODIMENTS

Hereinafter, embodiments of the all-solid-state battery and manufacturing method thereof of the present disclosure will be described in detail. It should be noted that the embodiments described below do not limit the all-solid-state battery nor the manufacturing method thereof of the present disclosure.

Without being bound by theory, the reasons why the all-solid-state battery of the present disclosure can suppress a decrease in battery capacity while reducing the possibility of a short circuit even when comprising plurality of unit cells will be explained using the drawings, regarding the findings obtained by the present inventors.

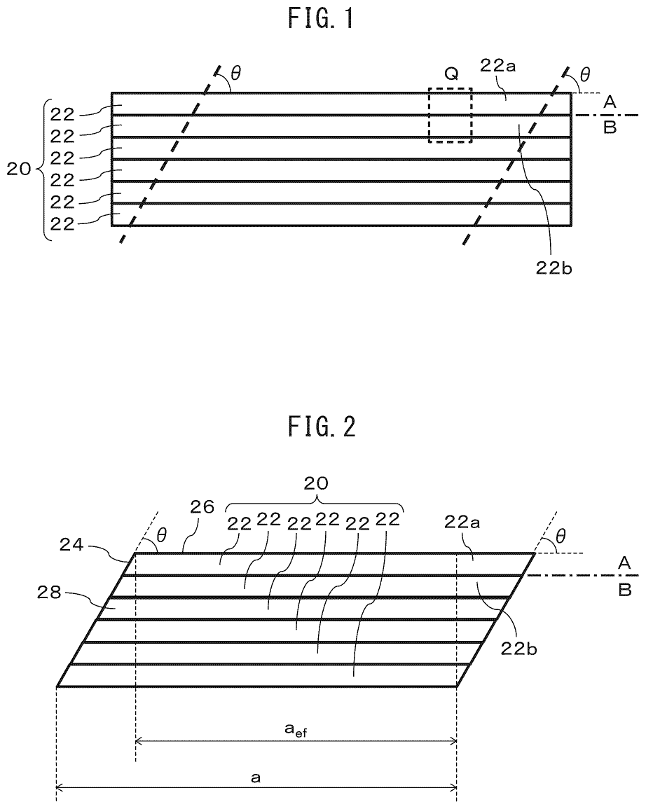

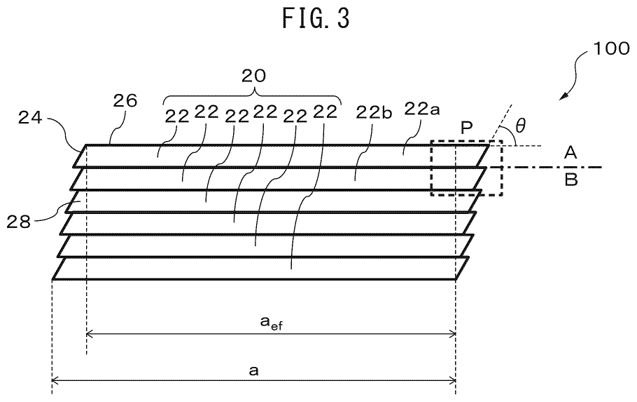

FIG. 1 is a cross-sectional schematic view showing an example of a manufacturing method for an all-solid-state battery. FIG. 2 is a cross-sectional schematic view showing the structure of the laminate with an inclined surface. FIG. 3 is a cross-sectional schematic showing an example of a part of the laminate of the all-solid-state battery of the present disclosure. FIG. 4 is an enlarged cross-sectional schematic view of a region P shown by a dotted line in FIG. 3.

When the all-solid-state battery comprises a plurality of unit cells, if each layer is laminated into a desired shape, the number of processing steps becomes excessive. Therefore, as shown in FIG. 1, the laminate 20 may be cut. The dashed line in FIG. 1 represents the cutting plane.

Referring to FIG. 2, the cut laminate 20 comprises a plurality of stacked laminated units 22. When cutting out the laminate 20, the possibility of a short circuit can be reduced by providing an inclined surface to the end 28 of the laminate 20. The reason for this will be explained below.

Referring to FIG. 3, among the laminate 20, the range in which all the laminated units 22 overlap and the laminate 20 effectively functions as a battery is limited to the range indicated by “a_{ef}”, resulting in a decrease in battery capacity. In contrast, if the laminate 20 has no inclined surface, meaning that the lamination plane 26 and the end plane 24 are vertical, the range in which all the laminated units 22 overlap substantially corresponds to the range shown by “a”, preventing a decrease in battery capacity.

Therefore, as shown in FIG. 3, the positions of each laminated unit 22 are adjusted so that the laminate 20 has the minimum area projecting in the lamination direction of the laminated unit 22. This allows the range shown by “a_{ef}” to be brought closer to the range shown by “a” thereby suppressing the decrease in battery capacity.

Such position adjustment is achieved by sliding each laminated unit 22 relative to each other at the interface of the laminated unit 22. Therefore, each laminated unit 22 is configured with electrode elements in such a way that it can be laminated through the contact between the first electrode current collectors and the contact between the second electrode current collectors.

The configuration requirements of the all-solid-state battery and the manufacturing method thereof of the present disclosure, which have been completed on the basis of the knowledge explained so far, will be described with reference to the drawings.

### All-Solid-State Battery

As shown in FIG. 3, the all-solid-state battery 100 of the present disclosure comprises a plurality of laminated units 22. Each of the plurality of laminated units 22 is laminated on top of each other to form a laminate 20. In addition to the laminate 20, the all-solid-state battery 100 comprises an electrode tabs and an exterior casing (not shown). The electrode tabs and exterior casing may be of a known embodiment. Hereinafter, the laminated units 22 and the laminate 20 will be explained.

### Laminated Unit

Each end 28 of the plurality of laminated units 22 has an inclined surface towards each lamination plane 26 of the plurality of laminated units 22. The phrase “the end 28 of the laminated unit 22 has an inclined surface towards the lamination plane 26 of the laminating unit” means that the angle θ formed between the lamination plane 26 and the end plane 24 (0°<θ≤90° is within the range of 0°<θ<90°, i.e., that e is not equal to 90° (not vertical).

FIG. 4 is an enlarged cross-sectional schematic view of a region P shown by a dotted line in FIG. 3. The boundary indicated by the dashed-dotted line in FIG. 4 corresponds to the boundary between the laminated unit 22 indicated by reference numeral “22a” and the laminated unit 22 indicated by reference numeral “22b” in the region P shown by the dotted line in FIG. 3.

In each laminated unit 22, at least one set of a first electrode current collector 40, a first electrode active material layer 50, a solid electrolyte layer 60, a second electrode active material layer 70, and a second electrode current collector 80 is laminated in this order. A single set of the first electrode current collector 40, the first electrode active material layer 50, the solid electrolyte layer 60, the second electrode active material layer 70, and the second electrode current collector 80 constitutes a unit cell 30. In the embodiment shown in FIG. 4, two sets of unit cells are laminated within one laminated unit 22, but this is not limited thereto.

As shown in FIG. 4, the possibility of a short circuit of the unit cell 30 is greatly affected by the short-circuit distance d. The longer the short-circuit distance d, the lower the possibility of a short circuit in the unit cell 30.

The angle θ formed between the lamination plane 36 and the end plane 34 (0°<θ≤90°), the short-circuit distance d, and the thickness t of the solid electrolyte layer 60 has the relationship d=t/sinθ. Thus, when the end 38 of the unit cell 30 has an inclined surface towards the lamination plane 36, meaning that the end plane 34 is the inclined surface, then 0°<θ≤90°. Since 0<sinθ<1, it follows that d>t, thereby reducing the possibility of a short circuit. Conversely, when the end 38 of the unit cell 30 has no inclined surface towards the lamination plane 36, meaning that the end plane 34 of the end 38 of the unit cell 30 is perpendicular to the lamination plane 36, then θ=90°. Therefore, d=t/sin 90°=t, making it disadvantageous in terms of preventing short circuits.

The angle θ may be appropriately determined within the range of 0°<0≤90°. From the viewpoint of ensuring sufficiently the above-mentioned short-circuit distance d, it is preferable that θ is 60° or less, 55° or less, 50° or less, or 45° or less. From the viewpoint of preventing “chipping” and “cracking” of the end 38 of the unit cell 30, it is preferable that θ is 20° or more, 25° or more, 30° or more, or 35° or more.

### Laminate

As shown in FIG. 3, the laminate 20 has the minimum area projecting in the lamination direction of each of the plurality of laminated units 22. As a result, the overlapping range of all the laminated units 22 within the laminate 20 is maximized, thereby suppressing the reduction in battery capacity. The phrase “laminate 20 has the minimum area projecting in the lamination direction of each of the plurality of laminated units 22” typically means the following embodiment. That is, the center positions of each of the plurality of laminated units 22 are aligned with each other in the planar direction of the lamination units 22 and are laminated together, and the positions of the end planes 24 of the laminated unit 22 are also aligned with each other in the planar direction of the lamination units 22 and are laminated together.

The first electrode current collector 40, the first electrode active material layer 50, the second electrode active material layer 70, and the second electrode current collector 80, which are components of the laminate 20, may be a positive electrode current collector, a positive electrode active material layer, a negative electrode active material layer, and a negative electrode current collector, or may be a negative electrode current collector, a negative electrode active material layer, a positive electrode active material layer, and a positive electrode current collector, respectively.

Next, a positive electrode current collector, a positive electrode active material layer, a solid electrolyte layer, a negative electrode active material layer, and a negative electrode current collector will be described.

### Positive Current Collector

The material used for the positive electrode current collector is not particularly limited, and any material which can be used as a positive electrode current collector for an all-solid battery can be appropriately employed. Examples of the materials used for the positive electrode current collector comprise stainless steel (SUS), aluminum, copper, nickel, iron, titanium, carbon, or conductive resin, but are not limited thereto. It is preferable that the material used for the positive electrode current collector has oxidation resistance, and for example, aluminum is preferred.

### Positive Active Material Layer

The positive electrode active material layer contains a positive electrode active material and, optionally, a solid electrolyte, a conductive aid, and a binder. When a solid electrolyte is contained, the solid electrolyte constituting the solid electrolyte layer can be used.

The material of the positive electrode active material is not particularly limited. For example, the positive active material may be lithium cobalt oxide (LiCoO₂), lithium nickel oxide ((LiNiO₂), lithium manganese oxide (LiMn₂O₄), LiCO_{1/3}Ni_{1/3}Mn_{1/3}O₂, or heteroelement-substituted Li—Mn spinel represented by the composition Li₁₊ₓMn_{2-x-y}M_{y}O₄ (where M is at least one metal element selected from Al, Mg, Co, Fe, Ni, and Zn), which represents a composition of hetero-element-substituted Li—Mn spinel, but is not limited thereto.

### Solid Electrolyte Layer

The material used for the solid electrolyte layer is not particularly limited, and any material which can be used as a separator layer in a battery can be appropriately employed. The solid electrolyte layer may contain a solid electrolyte, and optionally a binder.

The material of the solid electrolyte is not particularly limited, and examples thereof comprise a sulfide solid electrolyte, an oxide solid electrolyte, or a polymer electrolyte.

Examples of the sulfide solid electrolyte include, but are not limited to, a sulfide-based amorphous solid electrolyte, a sulfide-based crystalline solid electrolyte, or an aldilodite-type solid electrolyte. Specific examples of sulfide solid electrolytes include, Li₂S—P₂S₅-based (such as Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li_{S}—P₂S₅—GeS₂ (such as Li₁₃GeP₃S₁₆, Li₁₀GeP₂S₁₂), LiI—Li₂S—P₂O₅, LiI—Li₃PO₄—P₂S₅, Li₇₋ₓPS₆₋ₓClₓ,; or combinations thereof, but are not limited thereto.

Examples of the oxide solid electrolyte include, Li₇La₃Zr₂O₁₂, Li₇₋ₓLa₃Zr₁₋ₓNbO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON), but are not limited thereto.

The sulfide solid electrolyte and the oxide solid electrolyte may be glass or crystallized glass (glass ceramic).

Examples of the polymer electrolyte include polyethylene oxide (PEO), polypropylene oxide (PPO), and copolymers thereof, but are not limited thereto.

### Negative Active Material Layer

The negative electrode active material layer contains a negative electrode active material and, optionally, a solid electrolyte, a conductive aid, and a binder. When a solid electrolyte is contained, a solid electrolyte constituting a solid electrolyte layer can be used.

The materials for the negative electrode active material is not particularly limited, and may be metal lithium, and may be a material capable of absorbing and releasing metal ions such as lithium ions. Examples of materials capable of absorbing and releasing metal ions such as lithium ions may include, but are not limited to, alloy-based negative electrode active materials, or carbon materials.

Alloy-based negative electrode active material is not particularly limited and may include, for example, Si alloy-based negative electrode active materials or Sn alloy-based negative electrode active materials. Si alloy-based negative electrode active materials include silicon, silicon oxides, silicon carbides, silicon nitrides, or solid solutions thereof. Further, Si alloy-based negative electrode active material may include a elements other than silicon, such as Fe, Co, Sb, Bi, Pb, Ni, Cu, Zn, Ge, In, Sn, and Ti. Sn alloy-based negative electrode active materials include tin, tin oxides, tin nitrides, or solid solutions thereof. Further, Sn alloy-based negative electrode active materials may include elements other than tin, such as Fe, Co, Sb, Bi, Pb, Ni, Cu, Zn, Ge, In, Ti, and Si. Among these, Si alloy-based negative active materials are preferred.

The carbon material is not particularly limited, and examples thereof include hard carbon, soft carbon, or graphite.

### Negative Electrode Current Collector

The material used for the negative electrode current collector is not particularly limited, and those which can be used as the negative electrode current collector of the all-solid battery can be appropriately employed. Examples of materials used for a negative electrode current collector comprise, for example, stainless steel (SUS), aluminum, copper, nickel, iron, titanium, carbon, or conductive resin, but are not limited thereto. It is preferable that the material used for the negative electrode current collector have reduced resistance, and nickel, for example, is preferred.

### Conductive Aid

The conductive aid is not particularly limited. For example, the conductive aid may be, a carbon material such as VGCF (Vapor Grown Carbon Fiber) and carbon nanofibers, and a metal material, but is not limited thereto.

### Binder

The binder is not particularly limited. For example, the binder may be materials such as polyvinylidene fluoride (PVdF), butadiene rubber (BR), polytetrafluoroethylene (PTFE), styrene butadiene rubber (SBR), or a combination thereof, but are not limited thereto,.

### Manufacturing Method

A method for manufacturing the all-solid-state battery of the present disclosure (hereinafter, sometimes referred to as “the manufacturing method of the present disclosure”) will now be described.

Manufacturing method of the present disclosure comprise laminated unit preparation, laminate formation, inclined surface formation, and position adjustment. Each of these steps will be described below.

### Laminated Unit Provision

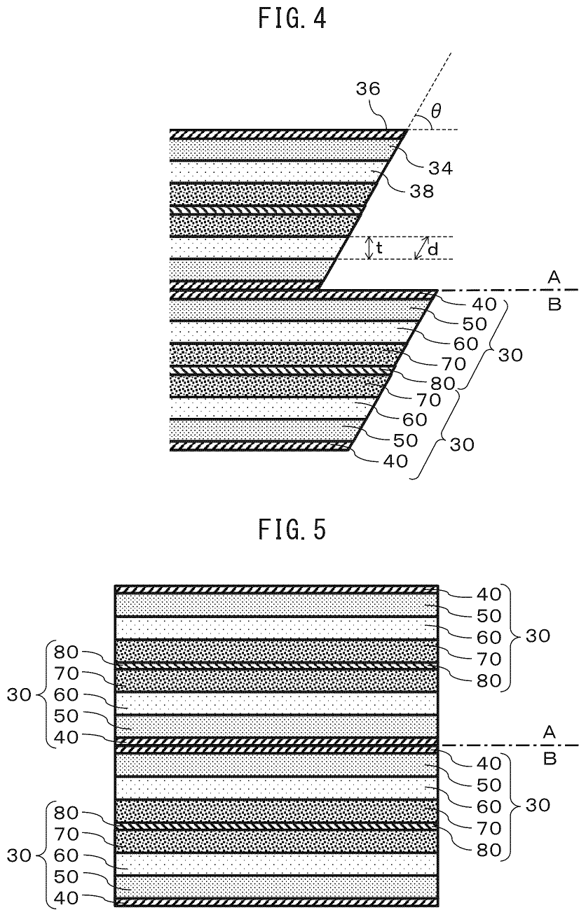

FIG. 5 is an enlarged cross-sectional schematic view of a region Q shown by a dotted line in FIG. 1. The boundary indicated by the dashed-dotted line in FIG. 5 corresponds to the boundary between the laminated unit 22 indicated by reference numeral “22a” and the laminated unit 22 indicated by reference numeral “22b” in the region Q shown by the dotted line in FIG. 1.

In the manufacturing method of the present disclosure, first, an individual laminated units 22 as shown in FIG. 1 are provided. In the laminated unit 22, at least one set of a first electrode current collector 40, a first electrode active material layer 50, a solid electrolyte layer 60, a second electrode active material layer 70, and a second electrode current collector 80 is laminated in this order. In the embodiment shown in FIG. 5, two sets are laminated, meaning that two unit cells 30 are laminated, but this is not limited to such a configuration. The laminated unit 22 may be a commercially available product, or at least one set of the first electrode current collector 40, the first electrode active material layer 50, the solid electrolyte layer 60, the second electrode active material layer 70, and the second electrode current collector 80 may be laminated in this order to obtain a laminated unit.

### Laminate Formation

A plurality of laminated units 22 are prepared, and each laminated units 22 is laminated together thorough contact between the first electrode current collectors 40 and contact between the second electrode current collectors 80, thereby forming the laminate 20. In the embodiment shown in FIG. 5, laminating is performed through contact between the first electrode current collectors 40, but this is not limited to such a configuration. Laminating may also be performed through contact between the second electrode current collectors 80, or through both contact between the first electrode current collectors 40 and contact between the second electrode current collectors 80.

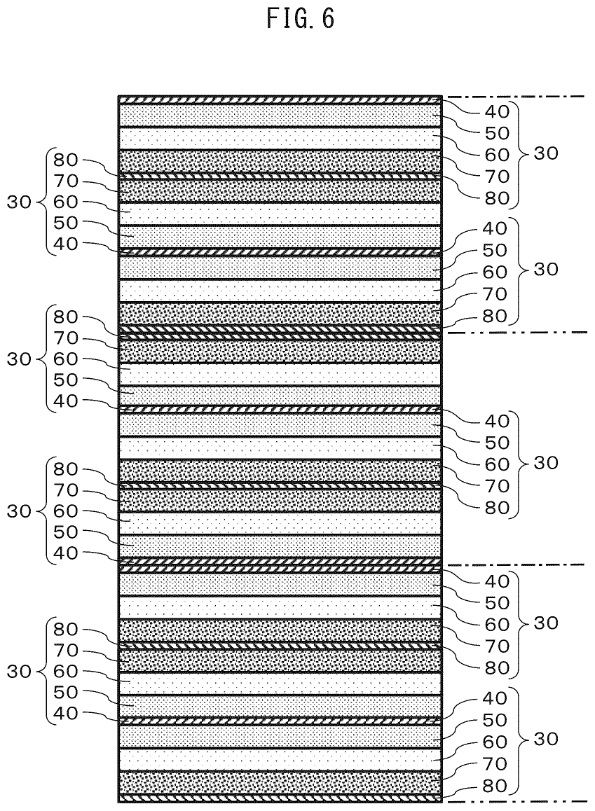

FIG. 6 is a cross-sectional schematic view showing another embodiment of the laminate formation. In FIG. 6, laminating is performed through both contact between the first electrode current collectors 40 and contact between the second electrode current collectors 80. In the embodiment shown in FIG. 6, the area enclosed by the dash-dotted line and the dash-double-dotted line represents one laminated unit 22.

### Inclined Surface Formation

An inclined surface 24 is provided at the end 28 of the laminate 20 towards the lamination plane 26. There is no particular limitation to the method for forming the inclined plane 24, but typically, as indicated by the dashed line in FIG. 1, this can be achieved by cutting and/or punching the laminate 20 at an angle θ relative to the laminated plane 26.

### Position Adjustment

The position each of the plurality of laminated units 22 are adjusted at the contact surfaces of the plurality of the laminated units so that the area projecting in the lamination direction of the laminate 20 is minimized. Individual laminated unit 22 within the laminate 20 in the state shown in FIG. 2, is moved along the contact surfaces to adjust its position. The contact surfaces refer to the lamination plane of the laminate 20, excluding the uppermost and lowermost lamination planes.

The contact surfaces between the first electrode current collector 40 and the first electrode active material layer 50, between the first electrode active material layer 50 and the solid electrolyte layer 60, between the solid electrolyte layer 60 and the second electrode active material layer 70, and between the second electrode active material layer 70 and the second electrode current collector 80 are fixed by a binder or the like contained in the first electrode active material layer 50, the solid electrolyte layer 60, and the second electrode active material layer 70. On the other hand, in the adjacent stacking units 22, the first electrode current collectors 40 and/or the second electrode current collectors 80 are in contact with each other.

Therefore, the adjacent stacking units 22 are not fixed, allowing each adjacent stacking unit 22 to move relative to one another.

There is no particular limitation to the method for adjusting the positions so as to minimize the area projecting in the lamination direction of the laminate 20, but a typical approach is as follows: The positions of the plurality of laminated units 22 are adjusted so that the center positions of each laminated unit 22 align with each other in the planar direction of the laminated units 22. Additionally, the positions of the end planes of the laminated units 22 are adjusted so that they align with each other in the planar direction of the laminated units.

### Deform

In addition to what has been described so far, various modifications can be made to the all-solid-state battery and manufacturing method thereof of the present disclosure within the scope of the content described in the claims. For example, in the cutting shown in FIG. 1, a plurality of laminates may be cut out in order to obtain plurality of all-solid-state batteries.

### REFERENCE SIGNS LIST

100 All-solid-state battery
10 Laminated precursor
14 Laminated sheet
20 Laminate
22 Laminated unit
30 Unit cell
24 Inclined surface
34 End plane
26, 36 Lamination plane
28, 38 End
40 First electrode current collector
50 First electrode active material layer
60 Solid electrolyte layer
70 Second electrode active material layer
80 Second electrode current collector

1. All-solid-state battery comprising a laminate of a plurality of laminated units,
wherein, in each of the plurality of laminated units, at least one set of a first electrode current collector, a first electrode active material layer, a solid electrolyte layer, a second electrode active material layer, and a second electrode current collector are laminated in this order,
wherein each of the plurality of laminated units are laminated with each other at least either contact between the first electrode current collectors or contact between the second electrode current collectors, thereby forming the laminate,
wherein each end of the plurality of laminated units has an inclined surface towards the lamination plane of each of the plurality of laminated units, and,
wherein the laminate has the minimum area projecting in the lamination direction of each of the plurality of laminated units.

2. The all-solid-state battery according to claim 1, wherein in each of the plurality of laminated units, a first electrode current collector, a first electrode active material layer, a solid electrolyte layer, a second electrode active material layer, a second electrode current collector, a second electrode active material layer, a solid electrolyte layer, a first electrode active material layer, and a first electrode current collector are laminated in this order.

3. A method for manufacturing an all-solid-state battery, comprising:
laminating at least one set of a first electrode current collector, a first electrode active material layer, a solid electrolyte layer, a second electrode active material layer, and a second electrode current collector are laminated in this order to obtain a laminated unit,
preparing a plurality of the laminated units and laminating each of the laminated units together by at least either contact between the first electrode current collectors or contact between the second electrode current collectors to form a laminate,
forming an inclined surface at the end of the laminate towards the lamination plane, and
adjusting the position of each of the plurality of laminated units at the contact surfaces of the plurality of the laminated units so that the area projecting in the lamination direction of the laminate is minimized.

4. The method for manufacturing the all-solid-state battery according to claim 3, providing the laminated unit in which the first electrode current collector, the first electrode active material layer, the solid electrolyte layer, the second electrode active material layer, the second electrode current collector, the second electrode active material layer, the solid electrolyte layer, the first electrode active material layer, and the first electrode current collector are laminated in this order.
